(19) United States
(12) Patent Application Publication
(10) Pub. No.: US 2014/0053407 A1
(43) Pub. Date: Feb. 27, 2014

(54) ELECTRIC SHAVING AND HAIR-CUTTING DEVICE

(71) Applicant: Yoav MICHAELY, Newton, MA (US)

(72) Inventor: Yoav MICHAELY, Newton, MA (US)

(21) Appl. No.: 13/902,817

(22) Filed: May 26, 2013

Related U.S. Application Data
(60) Provisional application No. 61/692,297, filed on Aug. 23, 2012.

(51) Int. Cl. B26B 21/40

(52) U.S. Cl. CPC B26B 21/405
USPC 30/49

(57) ABSTRACT

An electric shaver, as well as hair-cutting or hair-trimming device. The electric shaver includes: a base member to enable a user to hold the electric shaver; an electric motor to rotate at high speed; a shaft connected to the electric motor, the shaft rotating upon rotation of the electric motor; and a curved-contour shaving member attached to the shaft. The curved-contour shaving member includes: a curved-contour central member rotating due to rotation of the shaft; a blade spiraling or encircling around at least a portion of the curved-contour central member.

### CROSS-REFERENCE TO RELATED APPLICATIONS

The present application claims priority and benefit from U.S. Provisional Patent Application No. 61/692,297, titled “Electric Shaver Having Inter-Changeable Curved Shaving Heads”, filed on Aug. 23, 2012, which is hereby incorporated by reference in its entirety.

### FIELD OF THE INVENTION

The present invention relates to the field of electric shavers and hair-trimming devices.

### BACKGROUND

Electric shavers or electric razors are frequently used by millions of users. Some electric shavers require an electric cord for receiving power from an electric outlet; whereas other electric shavers may operate by using an internal battery, which may be rechargeable.

Some electric shavers utilize a rotating or oscillating blade. In some electric shavers, a lift-and-cut mechanism may be used, such that hairs may be lifted prior to their being cut by a rotating blade.

### SUMMARY

The present invention may include, for example, an electric shaver as well as other electric razors and devices for shaving, hair-cutting, or hair-trimming

In accordance with the present invention, for example, an electric shaver or hair-trimming device comprises: a base member to enable a user to hold the electric shaver; an electric motor to rotate at high speed; a shaft connected to the electric motor, the shaft rotating upon rotation of the electric motor; and a curved-contour shaving member attached to the shaft. The curved-contour shaving member comprises: a curved-contour central member rotating due to rotation of said shaft; a blade spiraling or encircling around at least a portion of said curved-contour central member.

In accordance with the present invention, the blade comprises a helix blade spiraling around the curved-contour central member and encircling the curved-contour central member.

In accordance with the present invention, the blade is slanted relative to said curved-contour central member.

In accordance with the present invention, the blade is slanted relative to said curved-contour central member at an angle of approximately 20 to 25 degrees.

In accordance with the present invention, the curved-contour shaving member is detachable from the shaft and replaceable with another curved-contour shaving member.

In accordance with the present invention, the curved-contour central member has a curved contour and is able to rotate at high speed upon rotation of said shaft.

In accordance with the present invention, the curved-contour central member has, exclusively, only curved contour regions and no flat contour regions; and the curved contour regions rotate at high speed upon rotation of said shaft.

In accordance with the present invention, wherein the curved-contour central member has at least one concave region which rotates at high speed upon rotation of said shaft.

In accordance with the present invention, the curved-contour central member has at least one convex region which rotates at high speed upon rotation of said shaft.

In accordance with the present invention, the curved-contour central member has at least one hourglass-shaped region which rotates at high speed upon rotation of said shaft.

In accordance with the present invention, the shaft passes through an Akulon ring which provides water-resistance to at least a portion of the electric shaver.

In accordance with the present invention, the shaft is integrated in the base member, and the curved-contour central member comprises a cavity into which said shaft is inserted, the cavity gripping firmly said shaft upon insertion.

In accordance with the present invention, the shaft is integrated in the curved-contour central member of the curved-contour shaving member, and the base member comprises a cavity into which said shaft is inserted, the cavity gripping firmly said shaft upon insertion.

In accordance with the present invention, the electric motor causes rotation of said curved-contour central member and said blade directly through rotating said shaft.

In accordance with the present invention, the electric motor causes rotation of said curved-contour central member and said blade directly through rotating said shaft, without any cog-wheel.

In accordance with the present invention, the electric motor causes rotation of said curved-contour central member and said blade exclusive through rotating said shaft and without any rotation-transfer mechanism.

In accordance with the present invention, the shaver further comprises a barrier surrounding said blade.

In accordance with the present invention, the barrier comprises a thin mesh.

In accordance with the present invention, the curved-contour shaving member is non-detachable from the base member.

In accordance with the present invention, the shaver further comprises: a hinge to connect the base member and the shaving member, the hinge enabling a user to modify an angel between the base member and the shaving member.

The present invention may provide other and/or additional benefits or advantages.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1A is a schematic illustration of a shaver, in an exploded view, in accordance with some demonstrative embodiments of the present invention;

FIG. 1B is a schematic illustration of the shaver, in a partially exploded view, in accordance with some demonstrative embodiments of the present invention;

FIG. 1C is a schematic illustration of the shaver, fully assembled, in accordance with some demonstrative embodiments of the present invention;

FIG. 1D is a schematic illustration of the shaver, partially disassembled, in accordance with some demonstrative embodiments of the present invention;

FIG. 2 is a schematic illustration of a set of multiple shavers, in accordance with some demonstrative embodiments of the present invention;

FIG. 3 is a schematic illustration of another set of multiple shavers, in accordance with some demonstrative embodiments of the present invention;

FIG. 4 is a schematic illustration of a shaver set, in accordance with some demonstrative embodiments of the present invention; and

FIG. 5 is a schematic illustration of another shaver set, in accordance with some demonstrative embodiments of the present invention.

### DETAILED DESCRIPTION OF THE PRESENT INVENTION

In the following detailed description, numerous specific details are set forth in order to provide a thorough understanding of some embodiments. However, it will be understood by persons of ordinary skill in the art that some embodiments may be practiced without these specific details. In other instances, well-known methods, procedures, components, units and/or circuits have not been described in detail so as not to obscure the discussion.

Applicant has realized that existing manual (non-electric) shavers and/or existing electric shavers utilize a generally-straight cutting platform comprising a generally-flat cutting plane. However, the human body and its organs are not flat, and include many curves; and therefore existing shavers may not adequately provide a perfect shaving experience and/or perfect shaving results.

The present invention may include an electric shaver (or trimmer, hair-cutting device) with inter-changeable shaving heads, such that a shaving head may be curved and/or concave and/or convex and/or may have particular structure or shape (e.g., parabolic, hyperbolic, egg-shape, American football shape, or the like).

The present invention may include a generally-elongated yet curved shaving head which may spin or rotate or oscillate rapidly, thereby rotating a blade (e.g., similar to a rotating drill or a spinning drill-bit). The curved shaving head, or shaving member, may include one or more curves which may optionally conform to, or accommodate, the human body or region(s) thereof.

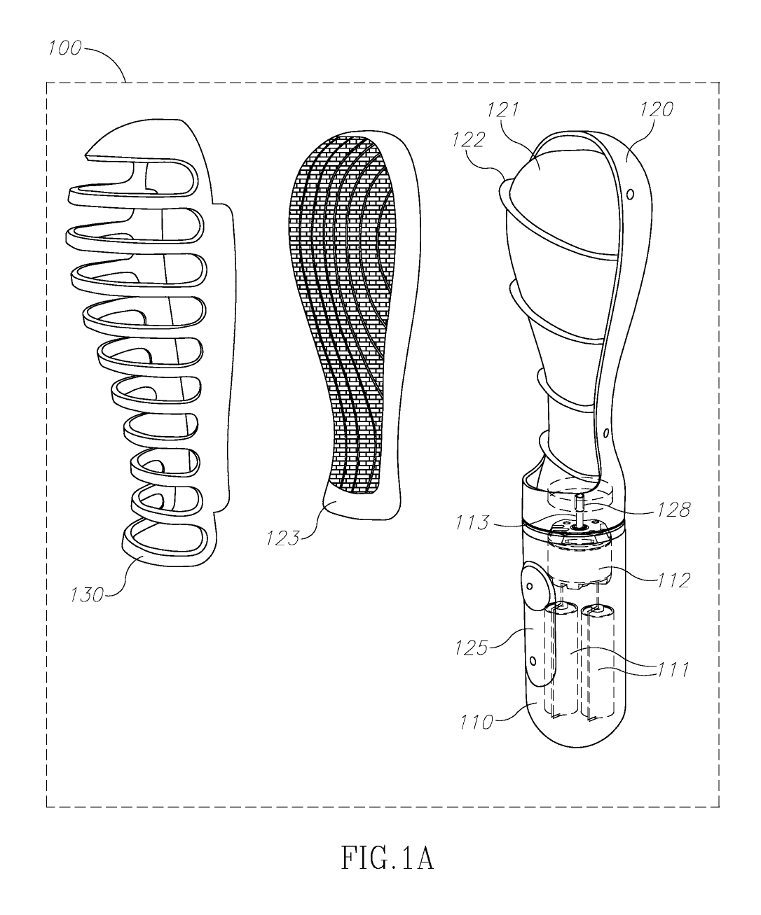

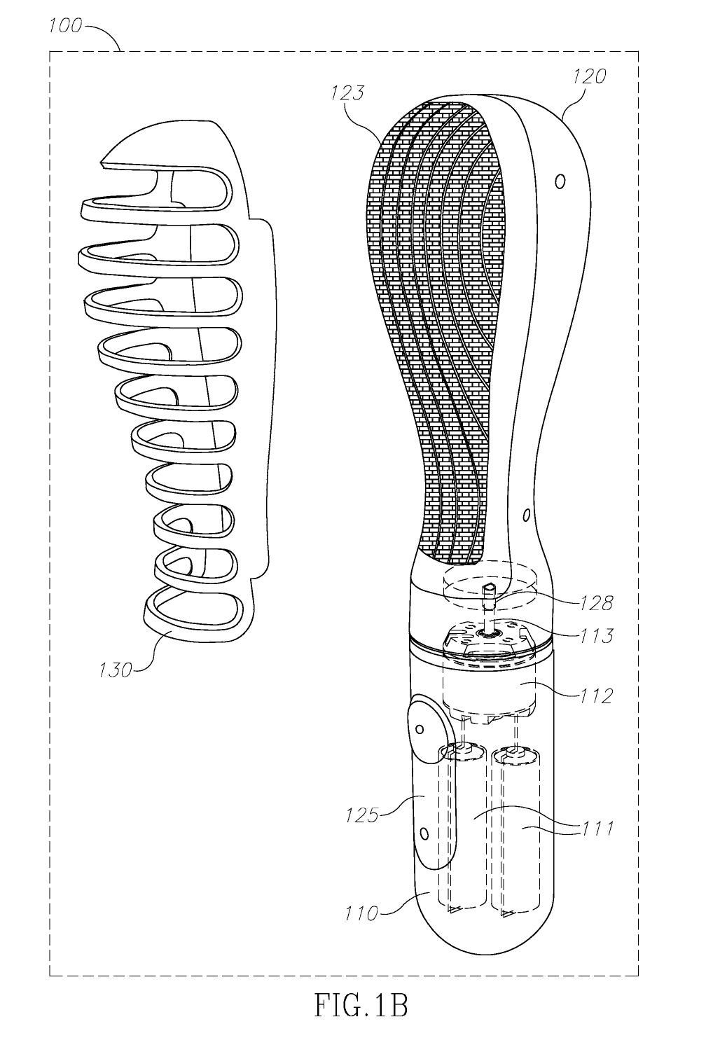

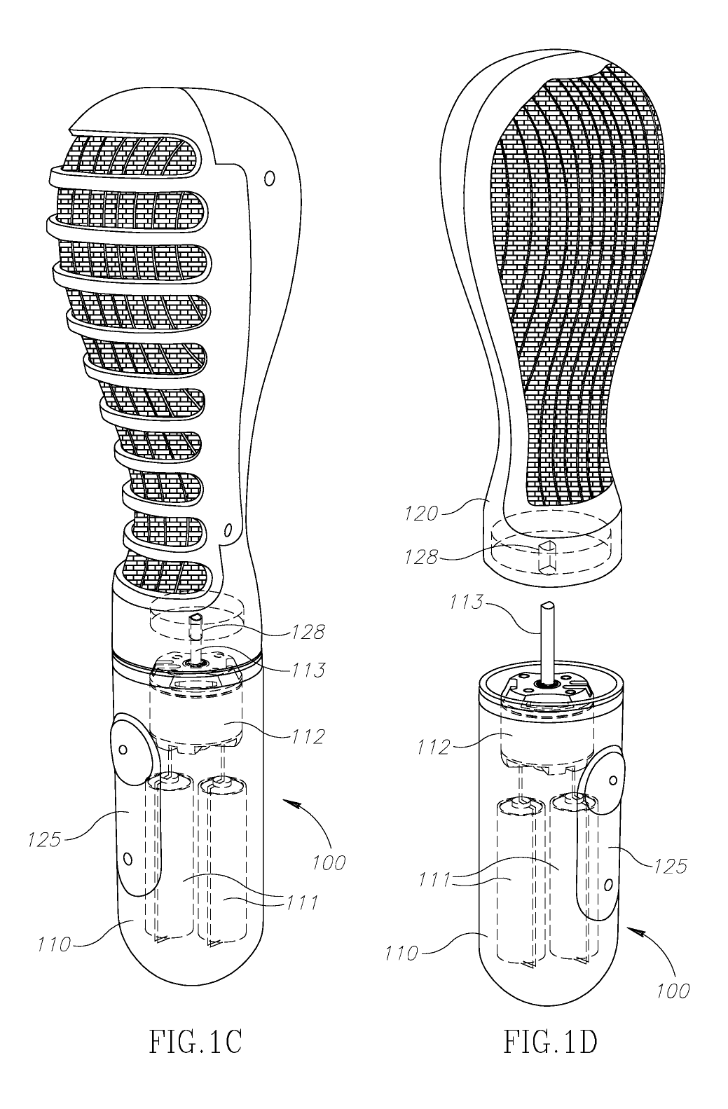

Reference is made to FIGS. 1A-1D, which are schematic illustrations of a shaver 100 in accordance with some demonstrative embodiments of the present invention. Shaver 100 may comprise, for example, a base member 110 and a shaving member 120.

Base member 110 may be or may include a handle or a grip or holding unit or other element which may be held by a user. Base member 110 may further comprise a power source 111, for example, an internal battery, a rechargeable battery, a replaceable battery, or the like. Power source 111 may produce and/or receive and/or provide direct current (DC) or alternating current (AC) to one or more electric components of shaver 100. Optionally, power source 111 may be associated with or connected to an external charger or charging unit, or may be placed into or onto or in proximity to such external charger to receive power and/or to recharge. Power source 111 may be recharged, for example, by connecting it through a metal cable to a power outlet; or by using an optional charging port of base member 110 which may utilize induction charge and avoiding bare metal contacts. Additionally or alternatively, power source 111 may be connected (e.g., via an electricity cable or cord) to an electric outlet (e.g., directly or through an adapter or electric transformer) to receive power or to recharge. In some embodiments of the present invention, optionally, power source 111 may not include any internal battery and/or any rechargeable battery, and may comprise a suitable circuit or mechanism able only to receive external power (e.g., AC power from an electricity outlet via an electricity cable or cord) and to immediately provide power to electric components of shaver 100 without storing power for subsequent (e.g., cordless) use.

Base member 110 may comprise an electric motor 112, which may operate using electric power, for example, Direct Current (DC). In some embodiments of the present invention, electric motor 112 may cause high-speed rotation or spinning (e.g., of itself, or of a connected component or element such as shaft 113) at approximately 5,000 or 7,500 or 8,000 or 10,000 or 12,000 or 13,000 or 14,000 or 15,000 or 18,000 or 20,000 Rounds Per Minute (RPM). In some demonstrative embodiments of the present invention, approximately 13,000 or 14,000 RPM may be achieved, for example, by utilizing power of 4.5 Volts and 110 milli-Amper. In some embodiments of the present invention, the term “high-speed rotation” or “high-speed spinning” may include, for example, rotation or spinning at a rate of at least 2,000 RPM. Other suitable values of RPM, voltage and/or current may be used.

Shaft 113 may extend upwards from electric motor 112 (e.g., similar to a shaft protruding out of an electric toothbrush device having inter-changeable toothbrush heads). Optionally, shaft 113 may pass through an Akulon ring, or other suitable material or component, or may have other coating or protection layer or mechanism, thereby making base member 110 water resistant.

The user may connect to shaft 113 one of several optional shaving members 120, and may inter-change among such shaving members 120, e.g., by pulling-out or disconnecting or detaching a first shaving member 120, and pushing-in or connecting or attaching a second shaving member 120. Such shaving members 120 (and/or their respective blade or blades) may include, for example: a generally-concave shaving member or blade; a generally-convex shaving member or blade; an hourglass-shaped shaving member or blade (e.g., particularly suitable for shaving an outside curve area, a leg or a chin); a generally oval shaving member or blade, or rocket-shaped shaving member or blade (e.g., particularly suitable for shaving an armpit); a combined or dual-curvature or multiple-curvature shaving member or blade, for example, having both inward curve(s) and outward curve(s), or having both concave region(s) and convex region(s), or having an upper-half of an oval shaving member and a lower-half of an hourglass shaving member); a shaving member or blade shaped as a cone or a conical member (which may be cut-off or rounded near its top portion); a generally cylindrical shaving member or blade; or the like.

Shaving member 120 may comprise a central member 121, as well as a blade 122 which may wrap around or spiral around or encircle around central member 121. For example, blade 122 may comprise one or more sharp and/or thin metal blade(s) which may spiral around central member 121, in a spring-like or helix pattern; protruding away from central member 121 an angle of, for example, approximately 20 to 25 degrees, or approximately 40 to 45 degrees, or approximately 55 to 60 degrees. In some embodiments of the present invention, blade 122 may encircle around central member 121 in a non-helix way and/or in a non-spiral way; or blade 122 may spiral around central member 121 in a non-helix way. In some embodiments of the present invention, blade 122 may comprise a set of one or more blades which may partially-encircle around portion(s) of central member 121, optionally in a slanted or diagonal manner running around or along central member 121, optionally such blades 122 being evenly spaced-apart among themselves. Other suitable structures or shapes may be used for blade(s) 122. In some embodiments, blade 122 may comprises a helix or non-helix blade spiraling around the curved-contour central member 121 and encircling (partially or entirely) the curved-contour central member 121.

Central member 121 may have the curved shape(s) and the curved contour as described above with reference to shaving member 120. Central member 121 may further comprise a cavity 128 or an aperture or hole or crater or central tunnel, which may run for approximately 10 to 50 millimeters along the longest dimension of central member 121, which may receive and grasp or firmly hold shaft 113 which may be inserted thereto (and which may be removed therefrom). It is noted that in some embodiments of the present invention, such cavity 128 or crater may be located in central member 121 in order to grasp the shaft 113 which may protrude upwardly out of base member 110; whereas, in other embodiments of the present invention, such cavity or crater may be located in base member 110 while the shaft 113 may protrude downwardly out of central member 121 (e.g., instead of protruding out of base member 110). In some embodiments, shaft 113 and cavity 128 may be complementing parts of a male-female connection mechanism, or may be male connector and female connector, or may be replaced by other suitable type of connection mechanism or holding or grasping mechanism.

In accordance with the present invention, base member 110 may be connected to shaving member 120 through shaft 113. The user may then turn-on or activate shaver 100, for example, by pushing or pressing or otherwise actuating an on/off button 125 of shaver 100 which may be located in or on base member 110. This may cause activation of electric motor 112, which may rotate or spin or oscillate at high speed, and may cause rapid rotation or spinning of shaft 113. Accordingly, central member 121, which may be connected to shaft 113 and may firmly hold or grasp shaft 113, may rapidly spin or rotate or oscillate together with shaft 113. As central member 121 spins or rotates or oscillates, blade 122 may spin or rotate or oscillate therewith, and may cut or trim or shave hair(s) of the user if blade 122 (or shaving member 120) is placed near or on a body-part of the user (e.g., face, neck, cheek, chin, leg, armpit, back, scalp, or other body organs). Due to the curved structure of shaving member 120 and/or central member 121, this may provide a convenient and/or pleasant and/or efficient shaving or trimming or hair-cutting experience, and may allow a faster shaving process (or trimming process or hair-cutting process).

Optionally, blade 122 or central member 121 or shaving member 122 may be (partially, or entirely) covered with or surrounded by a barrier 123, for example, a thin metal foil or mesh or net or foil formed of metal and/or other suitable material(s), to ease the shaving and/or to provide a more pleasant shaving experience and/or to allow blade 122 to grasp or catch and cut hair(s). Barrier 123 may further provide enclosure around blade 122, thereby optionally trapping or storing within such enclosure the hairs that were cut or trimmed (or portions thereof). Barrier 123 may be detachable or removable from central member 121, for example, to allow operation of shaver 120 without barrier 123, or to allow cleaning or brushing of blade 122. In some embodiments, barrier 123 may be required to allow proper operation of (e.g., hair cutting or hair shearing by) shaver 100. In other embodiments, optionally, shaver 100 may be structured such that blade 122 may cut hair without necessarily being encapsulated or housed within barrier 123 or behind barrier 123. In some embodiments, barrier 123 may be rigid, or semi-rigid, or flexible; or may allow partial passage of hair(s) through barrier 123, or may allow holding or grasping or capturing of hair(s) by barrier 123 to allow blade 122 to cut or shear hair.

In some embodiments of the present invention, blade 122 may comprise a single a spiral blade running spirally (e.g., optionally in a pattern which may be similar to a helix) around central member 121. Alternatively, blade 122 may comprise multiple blades or blade-regions or blade-rings or blade-units, which may partially encircle or partially surround central member 121 (or portions thereof). For example, blade 122 may comprise 5 or 8 or 10 or 12 blade units running down in a spiral pattern around the core blade shaft, at an angle of approximately 20 to 25 degrees relative to central member 121, each such blade unit encircling approximately 180 or 270 degrees of the 360 degrees circumference of a region of central member 121. In other demonstrative embodiments, blade 122 may comprise a set of spaced-apart ring-shaped blade units, each blade unit comprising a single ring which may encircle central member 121 and may be slanted relative to central member 121.

Blade 122 may be integral to or affixed to central member 121 which may rapidly spin or rotate, directly due to the fast rotation of shaft 113 which may be rotated by electric motor 112. Optionally, the present invention may obviate the need to include or to use gears or a power-transfer mechanism or rotation-transfer mechanism or cog-wheel(s), and may utilize direct rotation or direct spinning instead.

In some embodiments of the present invention, the spinning or rotation (e.g., rapid rotation) of blade 122 may create a shearing action (rather than a cutting action), with approximately 2,700 shears per second (e.g., calculated at: 13,500 rounds per minute, multiplied by 12 blade units, divided by 60 seconds in a minute), resulting in a cleaner and/or faster shaving process. Other suitable values may be used, and other suitable shear-per-second values may be achieved. In some embodiments of the present invention, the shearing action may further be beneficial since, for example, long hairs or relatively longer hairs may be sheared rather than being pulled out of the skin, thereby reducing or eliminating pain and/or skin irritation.

Optionally, shaver 100 may further comprise a spacer 130, which may be external to shaver 100 and/or external to shaving member 120. For example, spacer 130 may be placed upon, or attached or connected to, shaving member 120; and spacer 130 may be removed from, or detached or disconnected from, shaving member 120. Spacer 130 may create a space or gap (e.g., a small gap of approximately 1 or 2 or 3 or 5 millimeters) between barrier 123 and a skin or body organ on which shaver 100 may be used, thereby allowing the user to perform a trimming process in which hair(s) may be cut at a certain distance (e.g., of a few millimeters) away from the hair root or away from the skin, rather than at the skin or at the hair root. This may allow the user, for example, to maintain and/or shape a beard or a haired region, in which the user may desire to perform only hair-trimming which leaves some hair(s) protruding from the skin. Optionally, spacer 130 may be structured as a mesh or a filter or a net, or as bars or ribs which may have windows or apertures among them; or as other suitable structure which may provide the desired gap or buffer space or distance. Optionally, shaver 100 may be associated with a set of multiple types of spacers 130, which may have varying depth or thickness values (e.g., 1 millimeters, 3 millimeters, 5 millimeters, 10 millimeters, or the like), and such spacers 130 may be inter-changeable or replaceable to accommodate a particular user. It is clarified that spacer 130 may be a separate component from barrier 123 and non-integrated with barrier 123.

Shaver 100 may be structured or implemented such that base member 110 may be angular or slanted relative to shaving member 120, or vice versa. Although some of the drawings may depict, for demonstrative purposes, base member 110 at a flat angel of 180 degrees relative to shaving member 120, some implementations of the present invention may form base member 110 at other suitable angel (e.g., approximately 170 or 150 or 135 or 120 or 90 degrees, or other suitable value of degrees); and such angel may be fixed, or may be user-modifiable (e.g., by using a rotation axis or hinge(s) which may allow base member 110 to rotate or move relative to shaving member 120 and while remaining connected or detached to shaving member 120). In some embodiments of the present invention, optionally, based member 110 may comprise two or more sub-units; for example, a top sub-unit which may remain generally flat (e.g., at 180 degrees angel) relative to shaving member 120; and a bottom sub-unit which may move or rotate or become slanted relative to the top sub-unit (and relative to shaving member 120). Other suitable implementations may be used.

Optionally, shaver 100 may be structured as a partially-waterproof or entirely-waterproof device, by utilizing waterproof elements and/or coating and/or sealants, thereby allowing for wet and/or dry usage, as well as for easy cleaning by using a water tap and/or a dry brush.

Some embodiments of the present invention, particularly due to the curvature or the curved contour of shaving member 120, may provide a greater contact surface between blade 122 and the skin or hairs of the user, thereby shortening the required shaving time and expediting the shaving process (or hair-trimming process, or shearing process, or hair-cutting process).

Some embodiments of the present invention may allow a more convenient or more natural holding position or shaving position, utilizing the particular structure of shaver 100 and its curved shaving member 120.

In some embodiments of the present invention, inward curves and/or outward curves of shaving member 120 may conform to (or may resemble, or may accommodate or fit) the shape(s) or curvature of one or more body parts or body organs or body regions, and may make it easier for a user to shave a “corner” region or a curved or non-flat body part, a chin, a leg, a hip, an armpit, or the like.

Some demonstrative embodiments of the present invention may provide better and/or easier and/or smoother and/or more convenient shaving or hair-trimming or shearing or hair-cutting.

The present invention may further include a method of shaving, or a process of using an electric shaver or similar device for hair-cutting or hair-trimming. The method or process may comprise, for example: connecting or attaching a first (e.g., concave) shaving member to the shaft; utilizing the shaver (e.g., shaving) with the first blade; disconnecting the first shaving member from the shaft; connecting to the shaft a second (e.g., convex) shaving member having different curvature from the first shaving member; and utilizing the shaver (e.g., shaving) with the second shaving member.

In some embodiments of the present invention, curved-contour shaving member 120 may be detachable from base member 110, or vice versa. In other embodiments of the present invention, curved-contour shaving member 120 may be non-detachable from base member 110, or vice versa, or shaver 100 may be implemented as a monolithic device which may not allow separation or detachment between base member 110 and shaving member 120.

In some embodiments of the present invention, shaver 100 may be implemented such that electric motor 112 may not rotate unless base member 110 is attached to shaving member 120, or unless shaft 113 is covered or non-exposed. For example, a power circuit or electric circuit of shaver 100 may be implemented such that attachment of base member 110 to shaving member 120 may necessarily be required in order to close the electric circuit and allow electric motor 112 to rotate.

Shaver 100 may be used by men and/or women, by seniors and/or teenagers, for example, in order to shave the face, legs, armpits, private parts, or other body organs. Some demonstrative embodiments of the present invention may be used in order to shave and/or trim other living creatures (e.g., dog, cat, sheep, pet, or other animal).

Optionally, shaver 100 may comprise other suitable elements or components that may commonly be included in other shavers; for example, an on/off button to activate and de-activate shaver 100; a LED indicator or other light indicator(s) to indicate operation, or to indicate that a charging process is performed, or to indicate that charging is completed; a set of lights or LEDs or a screen indicating the percentage of power left, or the percentage of shaving-time left until charging is required, or the number of minutes of shaving that are left until charging is required (e.g., optionally utilizing a controller or processor to convert the charging level of power source 111 into percentage representation or time-units representation).

In some embodiments, instead of (or in addition to) utilizing electric motor 112 to spin or rotate the shaft 113, other type of rotating component may be used, for example a rotator unit which operate based on electric power, based on mechanical power or forces, by utilizing mechanical or manual gripping or squeezing operation of the user around base member 110, by utilizing a loaded spring mechanism (e.g., allowing the user to squeeze or pull or otherwise apply manual force to load or charge a spring which may then discharge and cause rotation or spinning), or other suitable mechanism. Accordingly, some embodiments of the present invention may include a non-electric shaver, or a shaver which may operate by utilizing both electric and non-electric (e.g., manual) source of power for causing rotation or spinning or oscillation of blade 122 and/or of central member 121.

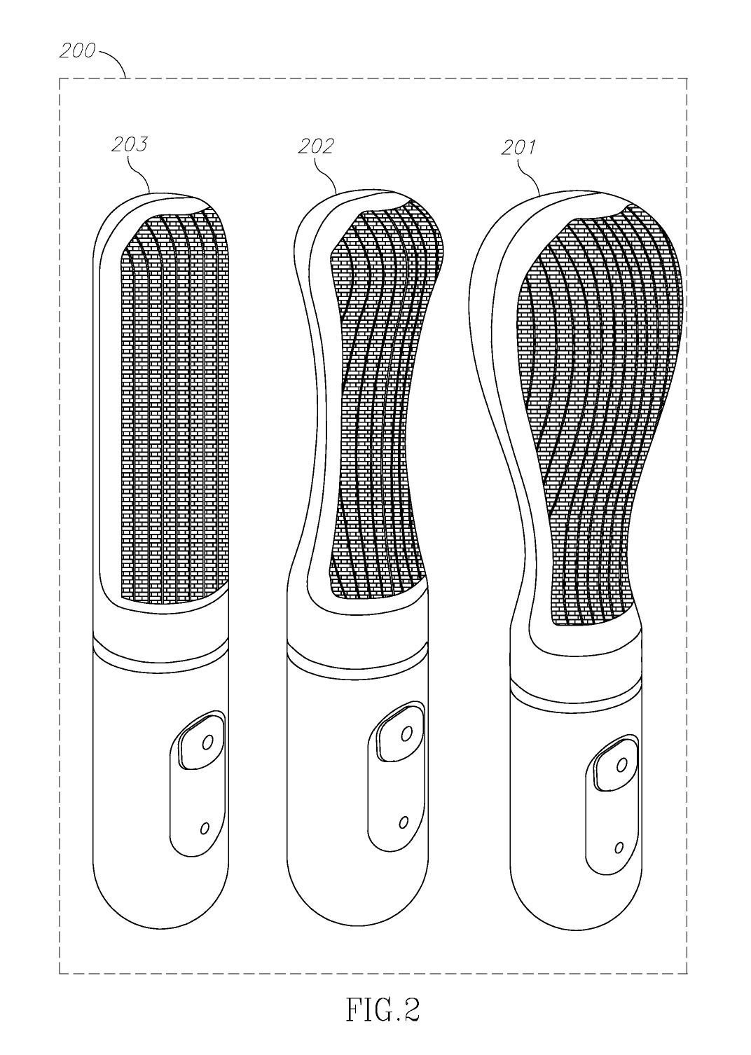

Reference is made to FIG. 2, which is a schematic illustration of a set 200 of multiple shavers, in accordance with some demonstrative embodiments of the present invention. Set 200 may include three shavers 201-203, each one of which may be generally similar to shaver 100 of FIG. 1C. Shavers 201-203 may differ from one another by the structure of their respective top portion (e.g., shaving member 120, and central member 121 contained therein), which may have different contours as depicted, to provide different shaving or hair-trimming experience and/or to better accommodate various (e.g., curved) body parts or organs. Optionally, the top parts (e.g., the shaving member 120) may be replaceable or inter-changeable among shavers 201-203, such that, for example, a single base member 110 may be attached to (and detached from) various different types of shaving member 120, such as the various shaving members depicted as part of shavers 201-203. Other suitable structures may be used.

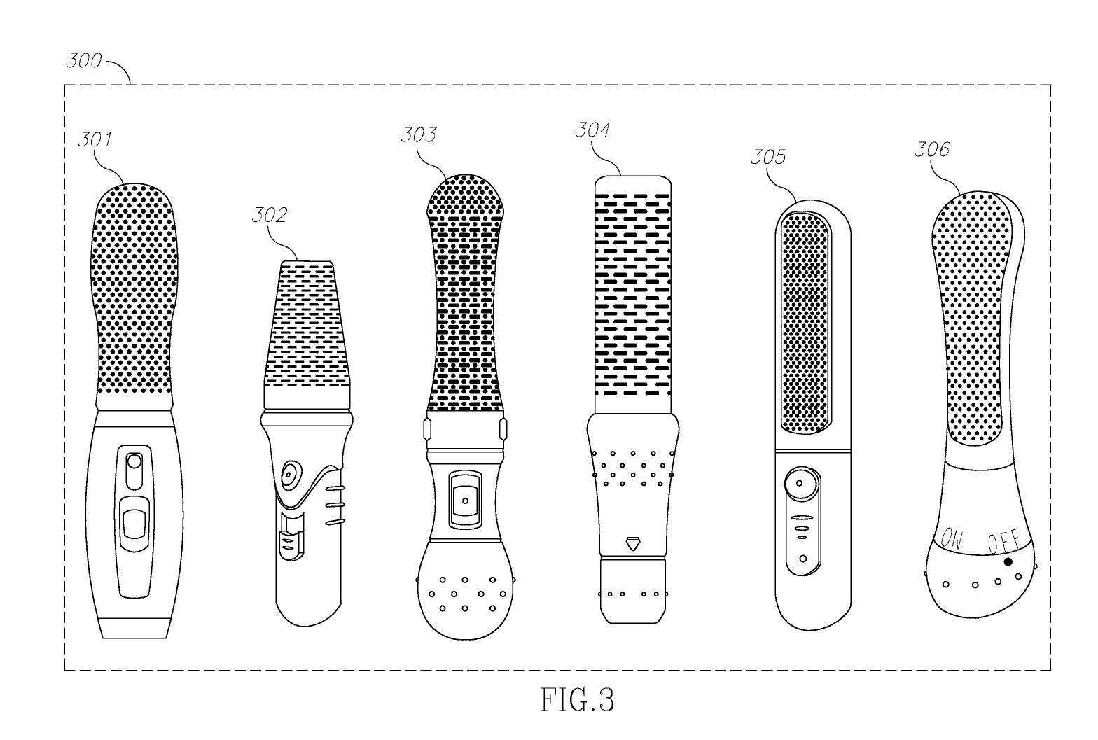

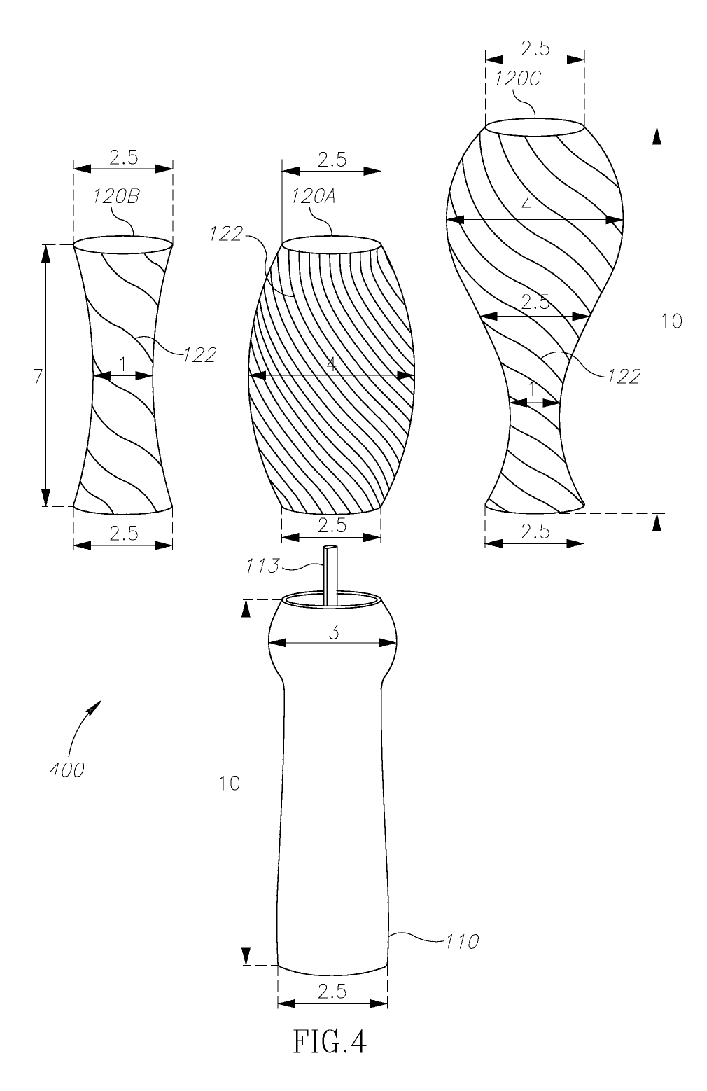

Reference is made to FIG. 3, which is a schematic illustration of a set 300 of multiple shavers, in accordance with some demonstrative embodiments of the present invention. Set 300 may include six shavers 301-303, each one of which may be generally similar to shaver 100 of FIG. 1C. Shavers 301-303 may differ from one another by the structure of their respective top portion (e.g., shaving member 120, and central member 121 contained therein), and/or by the structure of their lower portion (e.g., base member 110), which may have different contours as depicted, to provide different shaving or hair-trimming experience and/or to better accommodate various (e.g., curved) body parts or organs. Optionally, the top parts (e.g., the shaving member 120) may be replaceable or inter-changeable among shavers 301-306, such that, for example, a single base member 110 may be attached to (and detached from) various different types of shaving member 120, such as the various shaving members depicted as part of shavers 301-306. Other suitable structures may be used.

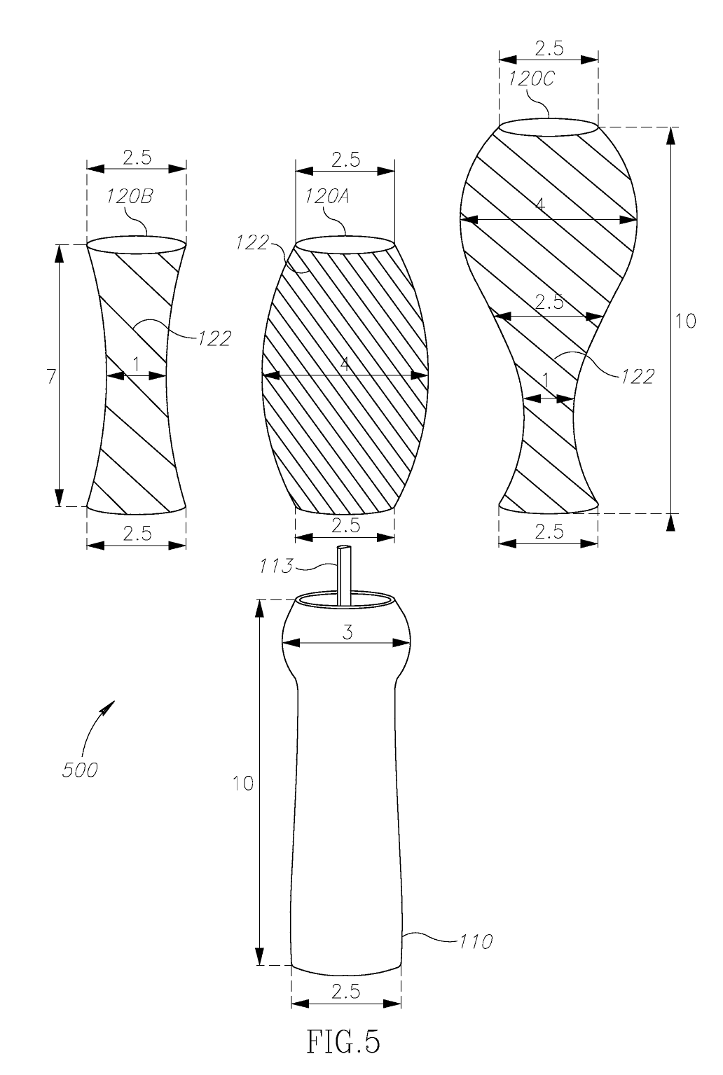

Reference is made to FIG. 4, which is a schematic illustration of a shaver set 400, in accordance with some demonstrative embodiments of the present invention. Shaver set 400 may comprise a single base member 110, as well as multiple inter-changeable shaving members, for example, shaving members 120A, 120B and 120C. Each one of shaving members 120A-120C may be generally similar to shaving member 120 of FIG. 1C, yet may have different contour or curved-contour, and may have different number, shape, density and/or direction of blade(s) 122. Each one of shaving members 120A-120C may be attached to (or detached from) base member 110 via the shaft 113, or via other suitable attachment/detachment mechanism or gripping mechanism or grasping mechanism, or other suitable mechanism which may both attach/detach the two members, as well as cause the shaving member 120A-120C to spin or rotate around its longest dimension due to such tight gripping or grasping of shaft 113. In the demonstrative example, depicted in FIG. 4, blades 122 are shown as spiral blades or spiraling blades or helix-shaped blades, which encircle or surround the core of shaving member 120A-120C while also spiraling upwardly or while being curved or non-straight.

Reference is made to FIG. 5, which is a schematic illustration of a shaver set 500, in accordance with some demonstrative embodiments of the present invention. Shaver set 500 may be generally similar to shaver set 400 of FIG. 4; however, while blades 122 in FIG. 4 are curved or spiraling, the blades 122 in FIG. 5 may be non-curved, non-spiral, non-spiraling, and may encircle or surround the core of shaving member 120A-120C without having a spiral or a helix structure. Optionally, blades 122 in FIG. 5 may be generally parallel to each other, and may be spaced-apart in generally identical distances among blades 122. Other suitable shapes may be used.

The term “shaving” as described herein may include other suitable operations such as, for example, trimming hair, cutting hair, shearing hair, removing hair pulling hair or disconnecting hair from its root, or other suitable actions which may result in or may include hair removal or hair shortening or hair cutting.

The term “shaver” as used herein may optionally include or may further include, for example, a razor, an electric shaver, an electric razor, a device which may be used for “shaving” as defined above, a device used at home or at a hair-salon or a barber-shop, or the like.

Functions, operations, components and/or features described herein with reference to one or more embodiments of the present invention, may be combined with, or may be utilized in combination with, one or more other functions, operations, components and/or features described herein with reference to one or more other embodiments of the present invention.

While certain features of the present invention have been illustrated and described herein, many modifications, substitutions, changes, and equivalents may occur to those skilled in the art. Accordingly, the claims are intended to cover all such modifications, substitutions, changes, and equivalents.

What is claimed is:

1. An electric shaver comprising:
a base member to enable a user to hold the electric shaver;
an electric motor to rotate at high speed;
a shaft connected to the electric motor, the shaft rotating upon rotation of the electric motor;
a curved-contour shaving member attached to the shaft, the curved-contour shaving member comprising:
a curved-contour central member rotating due to rotation of said shaft;
a blade encircling around at least a portion of said curved-contour central member.

2. The electric shaver of claim 1, wherein the blade comprises a helix blade spiraling around the curved-contour central member and encircling the curved-contour central member.

3. The electric shaver of claim 1, wherein the blade is slanted relative to said curved-contour central member.

4. The electric shaver of claim 1, wherein the blade is slanted relative to said curved-contour central member at an angle of approximately 20 to 25 degrees.

5. The electric shaver of claim 1, wherein the curved-contour shaving member is detachable from the shaft and replaceable with another curved-contour shaving member.

6. The electric shaver of claim 1, wherein the curved-contour central member has a curved contour and is able to rotate at high speed upon rotation of said shaft.

7. The electric shaver of claim 1, wherein the curved-contour central member has, exclusively, only curved contour regions and no flat contour regions, and wherein the curved contour regions rotate at high speed upon rotation of said shaft.

8. The electric shaver of claim 1, wherein the curved-contour central member has at least one concave region which rotates at high speed upon rotation of said shaft.

9. The electric shaver of claim 1, wherein the curved-contour central member has at least one convex region which rotates at high speed upon rotation of said shaft.

10. The electric shaver of claim 1, wherein the curved-contour central member has at least one hourglass-shaped region which rotates at high speed upon rotation of said shaft.

11. The electric shaver of claim 1, wherein the shaft passes through an Akulon ring which provides water-resistance to at least a portion of the electric shaver.

12. The electric shaver of claim 1, wherein the shaft is integrated in the base member, and wherein the curved-contour central member comprises a cavity into which said shaft is inserted, the cavity gripping firmly said shaft upon insertion.

13. The electric shaver of claim 1, wherein the shaft is integrated in the curved-contour central member of the curved-contour shaving member, and wherein the base member comprises a cavity into which said shaft is inserted, the cavity gripping firmly said shaft upon insertion.

14. The electric shaver of claim 1, wherein the electric motor causes rotation of said curved-contour central member and said blade directly through rotating said shaft.

15. The electric shaver of claim 1, wherein the electric motor causes rotation of said curved-contour central member and said blade directly through rotating said shaft, without any cog-wheel.

16. The electric shaver of claim 1, wherein the electric motor causes rotation of said curved-contour central member and said blade exclusive through rotating said shaft and without any rotation-transfer mechanism.

17. The electric shaver of claim 1, further comprising a barrier surrounding said blade.

18. The electric shaver of claim 17, wherein the barrier comprises a thin mesh.

19. The electric shaver of claim 1, wherein the curved-contour shaving member is non-detachable from the base member.

20. The electric shaver of claim 1, further comprising:
a hinge to connect the base member and the shaving member, the hinge enabling a user to modify an angel between the base member and the shaving member.
